(19) United States
(12) Patent Application Publication
(10) Pub. No.: US 2013/0000482 A1
(43) Pub. Date: Jan. 3, 2013

(54) Sand Casting An Aluminum Diesel Piston With An As-Cast, Reentrant Combustion Bowl For Light Or Medium Duty Diesel Engines

(75) Inventors: Joseph C. Kopchick, Warren, MI (US); Mark A. Osborne, Grand Blanc, MI (US); Richard D. Ricchi, Lapeer, MI (US)

(73) Assignee: GM Global Technology Operations LLC, Detroit, MI (US)

(21) Appl. No.: 13/609,821

(22) Filed: Sep. 11, 2012

Related U.S. Application Data
(63) Continuation-in-part of application No. 13/109,033, filed on May 17, 2011.
(60) Provisional application No. 61/405,739, filed on Oct. 22, 2010.

(51) Int. Cl. B22C 9/02; F16J 1/00

(52) U.S. Cl. 92/172; 164/15

(57) ABSTRACT

An aluminum-based diesel engine piston and a method of making the piston. The method involves casting the piston with complex geometries, including undercut or reentrant features. The casting uses an aggregate disposable mold that can be removed from the as-cast part. In one form, the complex geometry includes an undercut combustion bowl formed in the piston dome, while in another, it may include an internal cooling passage. The undercut bowl and internal passages may be produced using the aggregate disposable mold.

### STATEMENT OF RELATED CASES

This application is a Continuation-In-Part of U.S. application Ser. No. 13/109,033, filed May 17, 2011, entitled SAND CASTING A DIESEL PISTON WITH AN AS-CAST, UNDERCUT COMBUSTION BOWL, now abandoned, which claims the benefit of Provisional Application Ser. No. 61/405,739, filed Oct. 22, 2010, entitled SAND CASTING A DIESEL PISTON WITH AN AS-CAST, UNDERCUT COMBUSTION BOWL.

### BACKGROUND OF THE INVENTION

The present invention relates generally to devices and methods for casting engine components, and more particularly to an advanced aluminum-based diesel piston with complex features and a method of casting the same.

Pistons used in internal combustion engines are typically made up of a head (also called a dome or crown), skirt, one or more ring grooves, and land between the grooves. More stringent emissions and efficiency requirements dictate that pistons will need to operate at closer to stoichiometric conditions, higher cylinder pressures, and in tighter packaging regimes in the future, which in turn will necessitate higher component loading and operating temperature conditions. This is particularly true for pistons used in diesel engines, which are increasingly being used to power passenger vehicles, in addition to being the predominant engine form for larger, commercial vehicles Likewise, more sophisticated dome designs are being developed to achieve a more thorough, efficient combustion process, which raises temperatures in the combustion chamber even more. These advanced dome designs, with their three-dimensional (3D) profiles, require more complex mold shapes, increasing the difficulty of casting the pistons, or necessitating the use of excessive machining to achieve the desired dome geometry.

Higher operating temperatures require the use of materials capable of operating under those conditions. Likewise, cooling schemes have been employed as a way to enhance the life of pistons and related high-temperature components. One way of achieving cooling is routing engine lubricant, which is already present, through passages (also known as galleries) formed in the piston. There is a significant benefit to cooling the dome because it is exposed directly to the combustion process. However, adding cooling channels further increases the difficulty of casting the piston.

Traditional nonexpendable forms of casting, such as permanent mold casting, are not well-suited to forming complex shapes. In particular, the permanent nature of the mold, coupled with the reentrant regions present in some shapes, such as the 3D dome shapes discussed above, limit the ability to retract the part once the casting has solidified. As a result, extensive machining of the casting is needed to produce the complex shapes. This additional machining contributes to the complexity and cost of permanent mold casting approaches. Part quality may also suffer with permanent mold casting. The presence of risers may impact the piston's microstructure and the amount of grain refinement that is achievable. For example, the relatively large thermal mass of the large risers tends to slow down solidification of the cast component, whereas faster cooling and the accompanying improved mechanical properties as evidenced by the presence of smaller secondary dendrite arm spacing (SDAS) are often desirable. There can be as much as a 20% difference in mechanical properties comparing the in-gate location to the riser sides.

To overcome the shape limitations of permanent mold casting, other approaches may be employed, including various forms of expendable-mold castings, such as investment (or lost-wax) casting, sand casting, or the like. Investment casting typically involves the use of an expendable mold and pattern, and uses a ceramic mold material where the part is solidified in the mold such that only minimal post-cast machining is required. A variant of the sand casting approach, known as salt core casting, employs techniques generally similar to sand casting, except that a water-soluble salt is employed for internal mold geometries, rather than a green or dry sand. Once the part is made, the salt mold can be washed away with water without subjecting the part to any additional thermal loads. Salt core casting has storage and handling concerns that lessen its appeal.

Another approach that has been used to create an as-cast dome is semi-permanent mold casting. This approach still requires that the combustion bowl be machined. As with the permanent mold castings discussed above, a significant amount of risering off the dome is also required. Furthermore, higher output (i.e., high-performance) pistons may also require bowl rim remelting. These additional processes add significantly to the cost of the piston. This is especially true for remelting work and bowl machining costs, and even more so for pistons configured to operate under high temperature and pressure conditions (also known as “heavy duty” applications as will be discussed in more detail below), such as high output diesel pistons. Such pistons may operate at cylinder pressures above 200 bar (even as high as to 230 bar) and reach temperatures above 400° C.; thus requiring the use of steel forgings at an even more significant cost impact.

Significant variations in operating conditions such as the temperature and pressure conditions referred to above necessitate corresponding configurational differences between heavy duty (which may include buses, tractors, over-the-highway trucks, construction equipment or the like) diesel pistons and those with light duty (which may include passenger cars, light trucks or the like) or medium duty applications, where diesel engine-powered vehicles (and their duties) are defined legislatively in the USA, Europe and elsewhere. For example, in the USA, distinctions may be drawn between heavy, medium and light duty engines by the gross vehicle weight rating (GVWR), where heavy duty vehicles are those weighing over a certain amount (for example, greater than 33,000 pounds under both federal and California guidelines), medium duty (for example, between 19,500 and 33,000 pounds under federal guidelines and 14,000 and 33,000 pounds under California guidelines) and light duty (for example, between 8,400 and 19,500 pounds under federal guidelines and 8,500 and 14,000 pounds under California guidelines) vehicles correspond to lower weights. Other metrics may also be used, where for example a medium duty diesel engine is one with a displacement of between about 4 liters and about 7 liters, while a heavy duty counterpart may have a displacement of between about 10 liters and 15 liters. Furthermore, within the context of diesel engines, the duty cycle may be defined by towing requirements (which in turn may dictate cylinder pressure). In particular, heavy-duty applications rely upon steel-based pistons such that they will withstand the harsh environments imposed on them by the temperatures and pressures mentioned above.

### SUMMARY OF THE INVENTION

One aspect of the invention is a method of making a diesel piston. In one embodiment, the method includes providing a pattern for the piston, the pattern including a dome and a reentrant bowl; forming a piston mold around the pattern, the mold comprising an aggregate material and a binder; removing the pattern from the piston mold; introducing molten metal into the piston mold; contacting the piston mold with a solvent for the binder and removing the binder and the aggregate; cooling the molten metal; and solidifying the molten metal to form the piston with the dome and the reentrant bowl with only minimal need for post-casting processing. In the present context, post-cast processing includes (but is not limited to) bowl machining, some finishing operations or other approaches. Substantial degrees of such post-cast processing are those activities that involve significant additional cost or time in order to prepare the as-cast part for its final form. Unlike significant post-cast machining or the like, routine or incidental cleaning or similar final preparation steps would not constitute substantial post-cast machining. Likewise, a substantially as-cast piston made in accordance with the present invention would not need such additional steps in order to define complex shapes such as the basic reentrant shape of the bowl inside the dome. Furthermore, the aggregate and binder typically make up the mold. As such, sand casting according to the present invention will not require the repeated generation of foam or wax patterns or the removal of such patterns from a ceramic mold prior to the casting. Moreover, cycle times under ablation casting are expected to be shorter (i.e., the time it takes from making the mold to producing a casting) since it is not necessary to completely solidify the casting before extracting it from the mold.

The use of the approach of the present invention is particularly advantageous for cast aluminum-based pistons for diesel engine applications (especially for light duty and medium duty engines where cylinder pressures are kept at about 200 bar or lower) relative to their iron-based counterparts. One reason for aluminum being the metal of choice is that it has roughly one third of the density of a steel-based component (which leads to weight reduction and a concomitant simplification of bearings and related support structure that is especially beneficial in components that rotate or translate at a high rate of speed). Another reason is that aluminum-based materials are very castable, including the ability to be formed at lower processing temperatures; this in turn favorably impacts tooling design, durability and cost. Furthermore, because the thermal conductivity of aluminum is twice that of steel, aluminum-based parts reduce the need for cooling oil to be circulated through galleries in the piston during engine operation, which in turn may simplify engine oil pump design. This higher thermal conductivity (and attendant ability to convey away excess heat) reduces the likelihood that the temperature regime around the crown and other combustion-adjacent components will produce an undesirable effect on emissions and efficiency. In addition, casting processes such as employed in the present invention allow for inclusion of details such as a hardened top ring groove and the aforementioned internal oil galleries to be formed as an inherent part of the casting process, whereas steel forgings would require a subsequent heat treatment, machining or assembly operations.

Additionally, casting tooling is more amenable to changes that may be required as consequence of validation test results or other design modifications. Moreover, a cast diesel piston may be optimized for mass in the as-cast state compared to the as-forged piston, even in situations where the casting is such that significant post-cast machining operations may be required.

As discussed above, while casting in general (and casting of aluminum-based metals in particular) is advantageous, there are limitations associated with certain types of casting operations. For example, semi-permanent and permanent mold casting processes are not well suited to forming complex shapes, such as the reentrant combustion bowls used in newer, higher-performance diesel pistons. The ablative approach associated with the present invention eliminates the need for extensive or substantial machining of the combustion bowl or other portions of the piston with reentrant features while still allowing inclusion of details such as the core for the oil gallery or a ferrous top ring groove insert. The ablation casting used in the present invention has some significant differences over the investment casting approach discussed above. For example, patterns in ablation casting are not expendable in the manner of an investment cast pattern. Whereas investment castings employ the use of slurry-based ceramic-based molds that are subsequently shattered or otherwise broken away from the cast part, ablation casting uses silica sand, zircon sand, chromite sand or the like that do not require repeated coating, stuccoing and hardening of the mold; significantly, the sand used in ablation casting is reusable. Thus, while the sand-based materials used to form the aggregate of the present invention may exhibit some ceramic-like attributes (including relative refractoriness), they are considered separate from ceramics in that they aren't converted (such as by such coating, stuccoing and hardening) into a different type of structure Likewise, solidification of the metal in an ablation casting starts in the mold after filling and is completed during water ablation of the mold. Ablation casting may still require some post-cast machining.

The ablative casting approach of the present invention—when used to form an aluminum-based diesel piston—also results in a fine and uniform as-cast microstructure. This is due (at least in part) to the lack of need for large risers that would slow solidification times and impact the amount of achievable grain refinement. By the present invention, grain structures within different parts of the piston may be tailored to the property sought to be optimized. Thus, thicker sections that may require more aggressive ablation and cooling could be cooled at different rates than thinner sections as a way to achieve a particularly desirable grain refinement or pattern. Other approaches, such as counter-gravity and related slow filling techniques, are expensive to set up. The faster mold filling times made possible by the sand molds of present invention, coupled with solidification by ablation of the mold may be advantageously used to avoid the difficulties of casting an aluminum-based piston with such slow filling techniques.

Modern complex components have traditionally not been amenable to net dimensional, one-piece or related near-net approaches. With regard to pistons in particular, casting complexity is typically reduced via casting discrete components separately. For example, the crown and ring band region may be cast then subsequently joined to a second component made up of the skirts, wrist pins or the like. Likewise, components with reentrant features (such as combustion domes) tend to further deviate from net shape, one-piece castings. Castings produced in accordance with the present invention do not require two-piece designs to achieve net dimensional attributes to a cast aluminum-based piston with undercut reentrant bowls and related complex features. As such, they may employ a monobloc construction form, where many (or all) of the features of the piston (such as the dome, ring grooves, oil gallery, skirts and pin bores) are formed as one solid piece. For example, monobloc configurations differ from an articulated piston in which the skirt moves independently of the pin or pin bore. Monobloc configurations may be cast as one piece, or they may be two separate pieces which have been rigidly joined (such as by welding) together. The pistons disclosed herein would be considered an as-cast monobloc aluminum design. Further, such castings may employ fast cooling and part extraction to ensure superior grain structures and high manufactured part throughput. Within the present context, the present inventors have determined that the use of aluminum pistons and a monobloc design are well-suited for non-heavy duty diesel engine applications, where operating pressures of no more than 200 bar are present. Furthermore, the present approach achieves the intricacies of the undercut bowl, oil gallery, cast-in ring groove insert and other features right out of the mold with little (or no) need for post-cast operations.

According to another aspect of the present invention, a one-piece cast aluminum-based piston with at least one reentrant feature (in particular, a bowl formed in the piston's dome) is disclosed. The piston is configured such that upon placement into and operation within a diesel engine, the piston can withstand an operating pressure up to about 200 bar cylinder pressure and a temperature up to about 400 degrees Celsius. Such properties allow it to operate over the normal life of the aforementioned light duty or medium duty diesel engine applications.

### BRIEF DESCRIPTION OF THE DRAWINGS

The following detailed description of specific embodiments can be best understood when read in conjunction with the following drawings, where like structure is indicated with like reference numerals and in which:

FIG. 1 is a partial perspective cutaway view of a diesel piston highlighting undercut, reentrant and related features that can be produced by the sand casting of the present invention;

FIG. 2 is an elevation cutaway view of a diesel piston in an as-cast condition; and

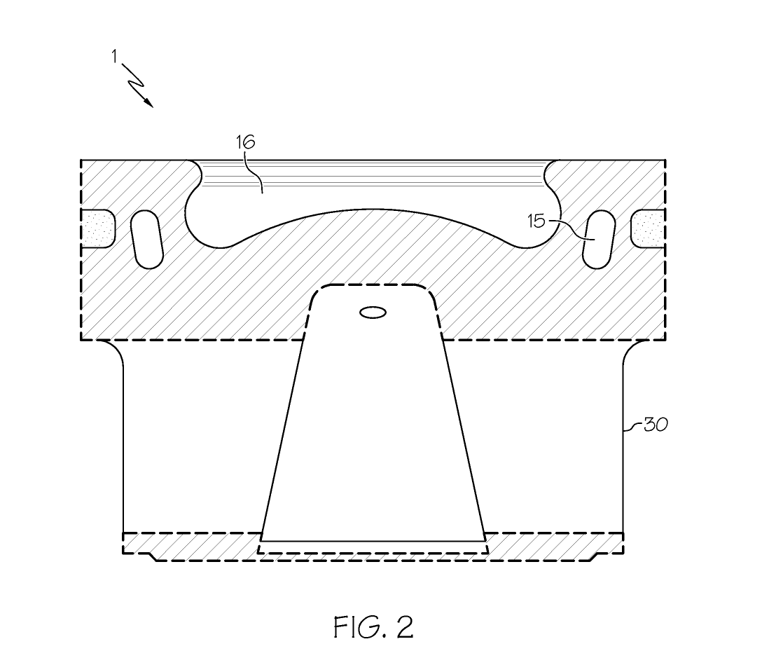

FIG. 3 is an elevation cutaway view of the diesel piston of FIG. 2 once final machining has been performed.

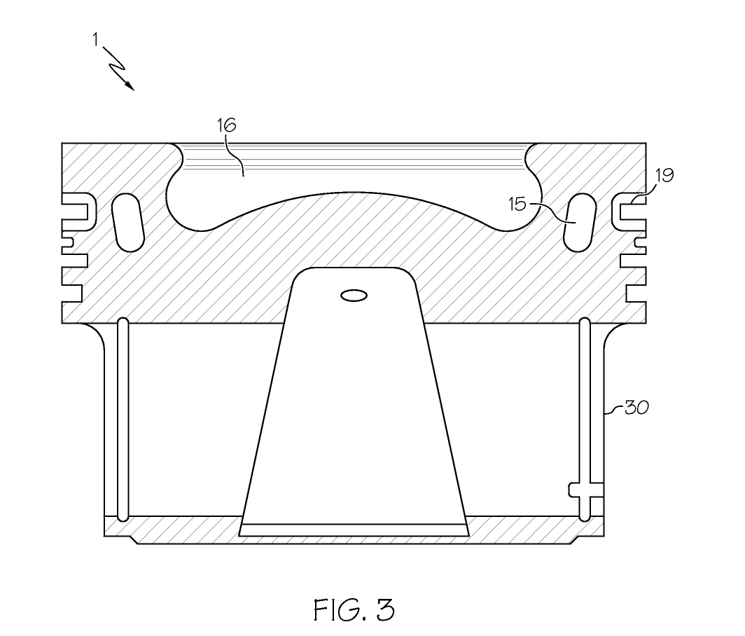

### DETAILED DESCRIPTION OF THE PREFERRED EMBODIMENTS

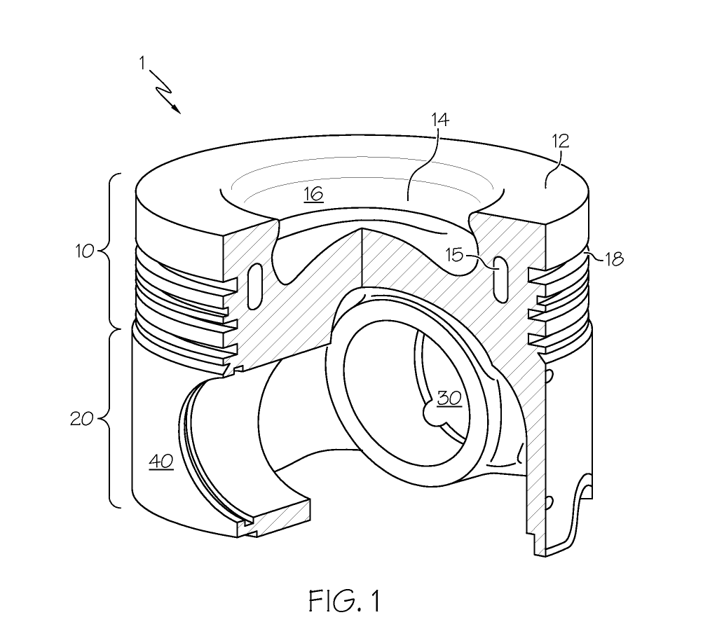

Referring initially to the figures, the features associated with an aluminum-based diesel piston that may be cast in a manner as taught here are shown. In particular, piston 1 includes a crown section (also referred to as a crown) 10, a skirt section (also referred to as a skirt) 20 and a wrist pin bore 30. The crown 10 defines a generally planar upper surface 12 that defines a generally dome-shaped combustion bowl 14 therein. The wall 16 of bowl 14 is contoured and terminates at the upper portion thereof with a lip such that the overhang created thereby defines reentrant features of bowl 14. The outer radial surface of the crown 10 includes various longitudinally-spaced, circumferentially-extending grooves 18 into which piston rings (not shown) may be inserted to help with combustion-sealing and oil-scraping functions. Groove inserts 19 may be placed in one or more of the grooves 18. Skirt 20 may include longitudinally downward-extending sidewalls into which ribs, flanges and related reinforcing structure (not shown) may be included. The skirt 20 helps maintain the alignment of the piston 1 during its reciprocating movement within an engine cylinder (not shown). Likewise, the wrist pin bores 30 are integrally formed into the side panels 40 (shown with particularity in FIG. 1) that make up part of skirt 20 to define a generally radial-extending passageway into which a pin is used to rotatably support the piston 1 on a connecting rod that traverses the cylinder in response to the rotational movement of a crankshaft (neither of which are shown). Numerous openings that form oil passages that make up the oil gallery are formed throughout the crown 10 to facilitate the passage of oil or a related coolant that is introduced into the cylinder.

An ablation casting approach can be used to produce a piston with a dome incorporating an as-cast, reentrant bowl, and an optional internal cooling passage. Ablation casting uses inorganic (i.e., water soluble) cores, and water is sprayed on the mold (preferably from numerous directions) which slowly washes away (hence the term “ablation”), rapidly cooling the casting. The rapid cooling results in improved material properties. In the present context, rapid cooling is that which takes place considerably faster than traditional (for example, investment casting) cooling approaches. Whereas an investment casting approach may require between a half an hour to an hour for adequate cooling, an aluminum-based diesel piston made in accordance with the present ablation casting may be cooled to room temperature in as little as three to five minutes. Furthermore, the application of water allows component solidification and cooling to be controlled separately from one another (e.g., by applying water to specific areas of the casting before others or by applying different amounts of water to different areas). Thus, ablation casting allows complex parts to be produced with a fine solidification microstructure throughout, if desired. By providing the high solidification rates and refined microstructure that are often needed to achieve the through-section higher mechanical properties (such as tensile and fatigue properties at room temperature and elevated temperatures), ablation casting allows parts combining both thin and thick sections, as well as those with complex internal cores, to be formed. The through-section properties are superior compared to those made using bowl rim re-melting, which only provides the desirable fine microstructure to a depth only slightly below the surface (e.g., a few mm).

The ablation casting process is described generally in U.S. Pat. No. 7,121,318, which is incorporated by reference herein. A pattern is formed from a material, and a mold is formed around at least a portion of the pattern. The mold is made of aggregate material and a binder.

The pattern is removed from the mold, and molten metal is then introduced into the mold. The mold is contacted with a solvent, and the molten metal is cooled so that it at least partially solidifies to form a casting. The cooling step includes contacting a shell of solidified metal around the molten metal with the solvent.

Ablation casting has not been used to cast diesel pistons in general, and more particularly diesel pistons with a reentrant bowl and even more particularly for aluminum-based diesel pistons with reentrant bowls or related undercut features.

U.S. Pat. Nos. 7,164,963, 7,618,823, and 7,225,049 describe analysis methods for lost foam casting (a type of ablation casting), each of which is incorporated by reference herein.

The use of ablation casting offers the possibility of casting the piston with a near-net-shape dome without the significant post-casting processing and/or machining required by other processes. Thus, the dome and combustion bowl can be cast simultaneously. In a particular form, the reentrant bowl 14 and internal passages would be produced by means of an aggregate disposable mold that could be produced by conventional core technology with retractable tooling in the molding die. In the present context, the aggregate form of the molding media includes, but is not limited to, silica sand, zircon sand, chromite sand, ceramic micro spheres, or the like.

The benefits associated with the present invention include, but are not limited to, one or more of the following: reduced machining costs, refined as-cast microstructure for improved mechanical properties, taking advantage of a sand (or related) molding process to tailor a reentrant region in the dome, reducing casting weight, and eliminating the need for an internal salt core. The traditional salt core could be replaced with an aggregate core of the same material as the piston mold.

In one form, sand casting can be used to produce the piston 1 of the present invention. This process would substantially reduce the massive risers that are typically used with permanent mold casting, resulting in improved material yield. Furthermore, the high cooling rate inherent in ablation casting makes it easier to tailor the process to achieve a refined microstructure with improved material properties. These improved material properties should provide a stronger piston 1 as a whole, as well as the needed piston bowl 14 rim strength (without having to re-melt this area) to pass rigorous head gasket validation tests consistently.

In one particular form, the mold can be made from sand that is capable of ablation casting such that complex dome shapes, including those with undercut and internal cooling passage features, may be easily and inexpensively manufactured. As such, a sand mold may be used as part of the ablation process.

Improved material yield can be realized by eliminating the large risers that are often used as part of a permanent mold casting operation. In particular, by using an ablation casting approach, the inherently high cooling rate can allow the piston 1 being formed to have a homogeneous microstructure and related structural properties.

In addition to the finer microstructure and enhanced piston properties, use of the ablation process permits much finer details to be cast into the part, including intricate cooling channels. The process reduces or eliminates the need for post-cast machining in the area around the dome or crown 10, particularly as it relates to the reentrant features of the combustion bowl 14, the wrist pin bore 30 and the cooling channel regions. Because the ablation casting is production-ready, scaling up to manufacture large quantities of pistons or related components is comparatively simple. An aggregate disposable mold could be employed to allow the combustion bowl 14 of the piston dome and a lubricating and cooling oil gallery (not shown) to be formed as part of the casting.

Employing ablation casting for diesel pistons helps to achieve a significant microstructural refinement by reducing or eliminating the need for expensive secondary post-casting processing such as machining or remelting. In situations where a refined microstructure is desired, such as the bowl edge or other complex 3D regions of the piston 1, tungsten inert gas (TIG) or laser remelting can be done locally (for example, in the reentrant region of combustion bowl 14). Subsequent machining, such as to yield proper shape of the bowl edge, may be similarly reduced or eliminated.

This invention takes advantage of the ablation casting process to eliminate the need for large risers at the piston dome or crown 10. The ability to cool the dome or crown 10 more quickly and uniformly should enhance mechanical properties. Thus, as soon as the mold is filled, the metal being cast starts to skin over. Before the solidification is complete, the mold passes through a water curtain formed by one or more of the spraying water jets (not shown) that are used to dissolve the mold away, and in the process effectively water cool the casting. In particular, the disposable aggregate mold should allow the combustion bowl 14 to be formed as-cast. Furthermore, the aggregate mold material may also be used to form the oil gallery 15 behind the top ring groove 18, eliminating the need for a salt core. This additionally allows for rapid prototyping of pistons, which can improve general development testing. Although not shown in the present cutaway views of the figures, it will be appreciated that one or more passageways may be integrally cast into piston 1 such that such passageway(s) may extend upward from a lower surface of the oil gallery 15 to facilitate the flow of oil into and out of the oil gallery 15. Other features—such as a passageway to facilitate oil dripping to a rod or pin—may likewise be formed into the lower surface of the piston 1.

Unlike steel pistons, where access ports and related openings to and from oil galleries are often oversized to ensure adequate core removal, the ablation casting approach for use on aluminum-based pistons of the present invention may remain small, as water-based solvents are able to penetrate such reduced-size openings. As discussed above, because pistons translate back and forth at rapid speed, any such simplifications such as the oil access line size reduction have multiplier-like ancillary benefits related to bearing and support structure design, as a designer may reduce the weight, complexity or related robustness of such structure. In one non-limiting embodiment of a piston design made according to the present invention, the holes used for the oil entry and exit ports of the oil gallery 15 are up to about 8 mm in diameter, and more particularly in the range of about 4 mm and 7 mm. Likewise, a drip lube hole may be comparably formed.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. For example, a “device” according to the present invention may comprise an electrochemical conversion assembly or fuel cell, a vehicle incorporating an electrochemical conversion assembly according to the present invention, etc.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

While certain representative embodiments and details have been shown for purposes of illustrating the invention, it will be apparent to those skilled in the art that various changes may be made without departing from the scope of the invention, which is defined in the appended claims.

What is claimed is:

1. A method of sand casting an aluminum-based piston for a light-duty or medium-duty diesel engine, the method comprising:
providing a pattern for the piston, the pattern including a dome and a reentrant bowl;
forming a piston mold around the pattern, the mold comprising an aggregate material and a binder;
removing the pattern from the piston mold;
introducing molten aluminum-based metal into the piston mold;
contacting the piston mold with a solvent for the binder and removing the binder and the aggregate; and
cooling the molten aluminum-based metal such that upon solidification the piston substantially defines the dome and the reentrant bowl that can withstand an operating pressure up to about 200 bar cylinder pressure and a temperature up to about 400 degrees Celsius.

2. The method of claim 1, wherein the aggregate material is a sand-based non-ceramic material.

3. The method of claim 1, further comprising rapidly cooling the molten metal.

4. The method of claim 3, wherein the rapidly cooling takes place in about 5 minutes or less.

5. The method of claim 1, wherein the piston comprises a crown section and a skirt section that are cast together as a single part to define a one-piece casting.

6. The method of claim 5, wherein the piston further comprises a wrist pin section that is cast together with the crown section and skirt section to define the one-piece casting.

7. The method of claim 1 wherein the binder is water soluble, and wherein the solvent is water.

8. The method of claim 1 wherein cooling the molten metal and solidifying the molten metal are controlled separately such that tailored grain structures within different portions of the piston are formed.

9. The method of claim 1 wherein cooling the molten metal comprises contacting a shell of solidified metal around the molten metal with the solvent.

10. The method of claim 1 further comprising:
providing a mold for an internal cooling passage, the mold for the internal cooling passage comprising a second aggregate material and a second binder;
placing the mold for the internal cooling passage in the piston mold before introducing the molten metal into the piston mold; and
contacting the mold for the internal cooling passage with a solvent for the second binder and removing the second binder and the second aggregate.

11. The method of claim 10 wherein the second aggregate material and the second binder are the same as the aggregate material and the binder for the piston mold.

12. The method of claim 1 wherein contacting the piston mold with a solvent for the binder comprises spraying the piston mold with the solvent.

13. A method of making an aluminum-based diesel piston for light-duty or medium-duty engine applications, the method comprising:
providing a pattern for the piston, the pattern including a dome and a reentrant bowl;
forming a piston mold around the pattern, the mold comprising an aggregate material and a water-soluble binder;
removing the pattern from the piston mold;
introducing molten aluminum-based metal into the piston mold;
contacting the piston mold with water and removing the binder and the aggregate;
cooling the molten metal; and
solidifying the molten metal to substantially form the piston with the dome and the reentrant bowl without post-cast processing of the piston such that upon solidification the piston can withstand an operating pressure up to about 200 bar cylinder pressure and a temperature up to about 400 degrees Celsius.

14. The method of claim 13 wherein cooling the molten metal and solidifying the molten metal are controlled separately.

15. The method of claim 14 wherein cooling the molten metal and solidifying the molten metal are controlled separately by applying water to one area of the piston before other areas or by applying different amounts of water to different areas of the piston.

16. The method of claim 13 further comprising:
providing a mold for an internal cooling passage, the mold for the internal cooling passage comprising a second aggregate material and a second binder;
placing the mold for the internal cooling passage in the piston mold before introducing the molten metal into the piston mold; and
contacting the mold for the internal cooling passage with a solvent for the second binder and removing the second binder and the second aggregate.

17. The method of claim 16 wherein the second aggregate material and the second binder are the same as the aggregate material and the binder for the piston mold.

18. The method of claim 13 wherein contacting the piston mold with water comprises spraying the piston mold with water.

19. A one-piece cast piston comprising an aluminum-based material with a reentrant bowl formed in a dome thereof, said piston configured such that upon placement into and operation within a diesel engine, it can withstand an operating pressure up to about 200 bar cylinder pressure and a temperature up to about 400 degrees Celsius.

20. The piston of claim 19, wherein said piston is configured for light duty or medium duty diesel engine applications.
